(19) United States
(12) Patent Application Publication
(10) Pub. No.: US 2013/0054280 A1
(43) Pub. Date: Feb. 28, 2013

(54) METHOD AND SYSTEM FOR ONLINE RENTAL OF NETWORKED REMOTE DEVICES

(71) Applicant: Mehran Moshfeghi, Rancho Palos Verdes, CA (US)

(72) Inventor: Mehran Moshfeghi, Rancho Palos Verdes, CA (US)

(21) Appl. No.: 13/587,142

(22) Filed: Aug. 16, 2012

Related U.S. Application Data
(60) Provisional application No. 61/526,163, filed on Aug. 22, 2011.

(51) Int. Cl. G06Q 10/02

(52) U.S. Cl. 705/5

(57) ABSTRACT

An online reservation method and system is described where networked remote devices, such as networked cameras, telescopes, and radio controlled cars, planes, ships, toys, robots are rented to interested renters. Renters use the reservation system to select devices from a group of remote devices offered for rent, reserve the devices for available time slots, and control the reserved devices remotely. Some embodiments provide tools for the users to record remotely operated sessions and to share live or previously recorded sessions with other users. The reservation system also manages auctions for reserving the use of high demand remote devices during certain time slots. Some embodiments allow a user who has reserved a remotely operated device for a time slot to rent it back to other users for a same or a different price that the user originally paid to reserve the use of the device during the time slot.

### CLAIM OF BENEFIT TO PRIOR APPLICATIONS

The present application claims the benefit of U.S. Provisional Patent Application 61/526,163, entitled, “Method and System for Online Rental of Networked Remote Devices,” filed Aug. 22, 2011. The contents of U.S. Provisional application 61/526,163 are hereby incorporated by reference.

### BACKGROUND

There are a growing number of electronic and sensing devices that are connected to a network such as the Internet and can be operated remotely. One example of a remote sensing device is a digital still or video camera that has Ethernet connections and allows remote control and viewing from anywhere in the world. Such Internet Protocol (IP) cameras provide controls for panning, tilt and zoom. These cameras are available or can be installed at points of attraction such as tourist sites, stadiums, concert halls, and museums. Other examples of networked remote devices include telescopes, and radio controlled cars, planes, ships, toys, robots, etc.

### BRIEF SUMMARY

Some embodiments provide a reservation method and system where networked remote devices are rented to interested renters. A user interested in renting a remote device uses the reservation system's application or web page to select a device from a group of remote devices, reserves the device during an available time slot, and controls the device remotely during the reserved time slot. Some embodiments enable users to record and share the information they receive from a rented remote device with others. A buyer, in some embodiments can become a seller and re-sell his/her reservation to another buyer. The reservation system, in some embodiments, provides a rewards system for device owners and renters.

The reservation system provides auctions for high demand remote devices and time slots in some embodiments. The networked devices include remotely controlled devices such as still camera, video cameras, telescopes, cars, planes, ships, submarines, toys, robots, etc.

A communication server is used by the reservation system to provide private chats, chat rooms, messaging and other communications for the registered users in some embodiments. An advertisement server is used in some embodiments together with a data-mining server to target the users with contextual and personalized advertisements while they are reserving and/or remotely operating the rented devices. Some embodiments allow users to store bookmarks inside the reservation system web page for particular rental devices, discussion threads, auctions, ratings, etc.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates an overview of the system of some embodiments of the invention.

FIG. 2 conceptually illustrates a process for selling access to remotely controlled devices in some embodiments of the invention.

FIG. 3 conceptually illustrates a process for a seller to sell access to remotely controlled devices in some embodiments of the invention.

FIG. 4 conceptually illustrates a process for reserving a remote device in some embodiments of the invention.

FIG. 5 conceptually illustrates a process for reserving and remotely operating a remote device in some embodiments of the invention.

FIG. 6 conceptually illustrates an exemplary user interface for a buyer who has logged into the reservation system in some embodiments of the invention.

FIG. 7 illustrates the interface after the buyer clicks on the “reservation calendar link” of rental camera device C3 in FIG. 6.

FIG. 8 conceptually illustrates a scenario where a stadium is equipped with IP video cameras at different locations in some embodiments of the invention.

FIG. 9 shows the view of buyer 1 in FIG. 8 from reserved camera 1.

FIG. 10 conceptually illustrates a process for a reservation auction in some embodiments of the invention.

FIG. 11 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

There is a business opportunity for the owners of networked remote controlled devices to generate extra revenue by renting them out to people worldwide. Some embodiments provide an online reservation system where owners of such remotely operated devices (sellers) find a steady flow of interested renters (buyers). The remotely operated devices are electronic and sensing devices such as cameras, telescopes, robots, toys, drone airplanes, submarines, ships, automobiles, etc., that can be remotely operated. A buyer uses the reservation system to select a device from a plurality of remote devices, reserves it for an available time slot, and uses it remotely with a computing device. The term buyer (or renter) is used throughout this Specification to refer to users who buy access to remotely controlled devices by reserving the devices in certain time slots. The buyers do not buy the actual devices but only buy the rights to use them within certain time periods. The reservation system also manages auctions for reserving the use of high demand remote devices and time slots.

### I. Reservation System for Reserving, Selling Access, and Remotely Operating Networked Devices

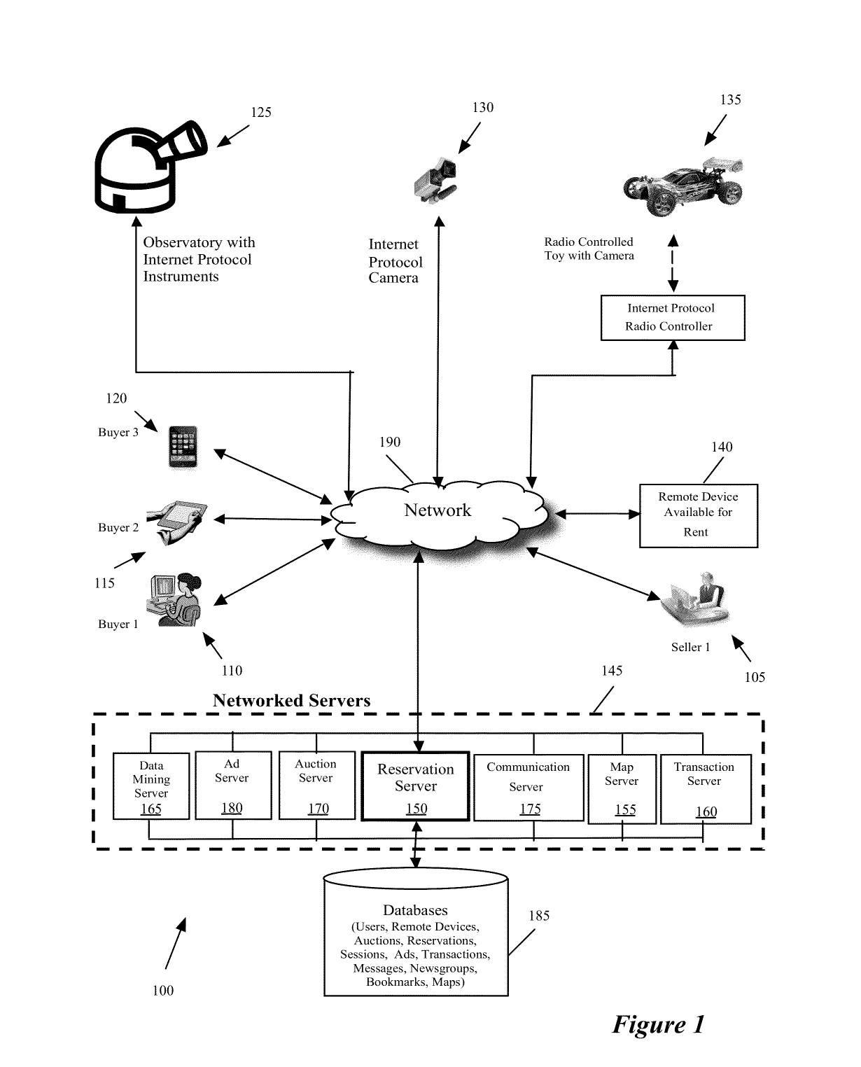

FIG. 1 conceptually illustrates an exemplary system of some embodiments of the invention. The system 100 is utilized for reversing, auctioning, selling, and advertising of remotely operated devises. In FIG. 1 some users such as seller 1 105 contact the reservation system through their electronic devices to post the availability of their networked remote sensing devices and sell access to them on certain dates/times. These users are referred to as sellers in this specification. Other users such as buyer 1 110, buyer 2 115, and buyer 3 120 contact the reservation system through their electronic devices to reserve and access a variety of networked remote sensing devices. These users are referred to as buyers (or renters) in this specification.

The remote devices 125-140 are connected to a network 190 such as the Internet with a wire-line or with a wireless method. These devices receive commands/data from authorized users and send back digital information. One example of a remote sensing device is an Internet Protocol (IP) digital still or video camera 130. A buyer in some embodiments uses the system to reserve a camera and pan, tilt, and zoom on an area of interest. Another example is an observatory with astronomical instruments 125 that are connected to the Internet (wired or wirelessly). A buyer in some embodiments uses the system to reserve a telescope, remotely control it, and view objects in the sky. Another example is a remote controlled device 135 such as a model radio-controlled car, plane, ship, submarine, robot, etc. Such devices receive their commands wirelessly from an IP radio controller that is networked and is remotely controlled by an authorized buyer. They also have a mounted camera so buyers can see their path as they remotely control the device. In other embodiments, the remote devices are controlled by satellite.

The reservation system owns some of the networked remote devices, leases some devices from sellers, and/or acts as an intermediary between sellers and buyers. Buyers such as buyers 110-120 access the system with a dedicated application or a web browser on a variety of computing client devices such as a personal computer (PC), laptop, tablet computer, cellular phone or Personal Digital Assistant (PDA). The network connection of these devices and the remote devices are either wired or wireless. Wireless connections may use an access point and use different standards such as 802.11*, cellular, Bluetooth, 60 GHz, Worldwide Interoperability for Microwave Access (WiMax), Radio Frequency Identification (RFID) and Ultra-WideBand (UWB). Each type of network can also have different implementations. For example, the WLAN 802.11 standard (also referred to as Wi-Fi) can include 802.11b, 802.11a, 802.11g, 802.11z, 802.11n and Wi-Fi Direct. The cellular network can include Code Division Multiple Access (CDMA), CDMA2000, Wideband CDMA (WCDMA), Time Division Multiple Access (TDMA), Frequency Division Multiple Access (FDMA), and other multiple access techniques.

The reservation system in some embodiments includes a group of servers 145 that access various databases. A reservation server 150 handles user registration, authentication, reservation, session handling, and rewards processing. The reservation server uses a number of other servers for specialized tasks. The other servers are either external servers that the reservation server company uses or they are internal and belong to the same entity. A map server 155 accesses a map database to generate maps and directions. A transaction server 160 is used to process payments. A data-mining server 165 is used to analyze historical data and patterns. An auction server 170 is used to carry out reservation auctions for high demand devices and special events. A communication server 175 is used by the reservation system and by registered users for chats, messaging and other communications. An ad server 180 is used together with the data-mining server 165 to target the users with contextual and personalized advertisements. These servers have access to a group of databases 185. The databases 185 include information about users (buyers and sellers), remote devices, previous and ongoing auctions, reservations, sessions, advertisements, transactions, messages, newsgroups/discussions, user bookmarks, and maps.

The reservation server owns the rental devices, leases them, or acts as an intermediate agent between sellers and buyers. In the latter case, the reservation system in some embodiments charges the seller a percentage of rental revenue, a flat fee, a combination of the two, or uses other business models.

### II. Selling or Auctioning Access to Remotely Controlled Devices

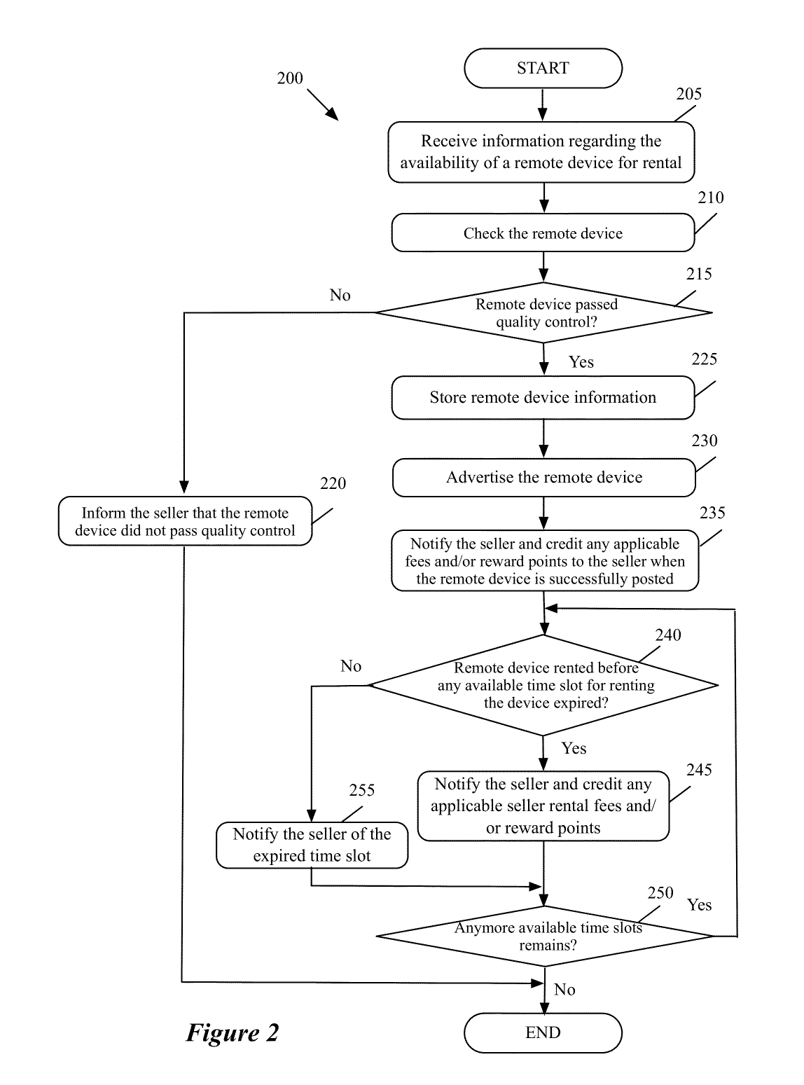

FIG. 2 conceptually illustrates a process 200 for selling access to remotely controlled devices in some embodiments of the invention. The process is used, e.g., by one or more of the servers of the reservation system in some embodiments. As shown, the process receives (at 205) information regarding the availability of a remote device for rental. For instance, the process receives the information when a seller contacts the reservation system to communicate the availability of a remote device for rental. The contact in some embodiments is a computerized communication where the seller logs into the reservation system and uses its messaging function or uses web site forms. The communication in some embodiments is informal where the seller makes a phone call to the reservation system company and the reservation system receives the information electronically entered in the system by an operator.

The information communicated by the seller to the reservation system includes device information, device availability dates/times, minimum required rent per unit of time, and device access information such as a URL link to it and a temporary username/password. The process then checks (at 210) the remote device. The remote device is checked e.g., for quality control purposes to determine whether the remote device is operational, the access information is valid, and/or the rental price is appropriate. The process then determines (at 215) whether the remote device passes quality control. If the remote device does not pass the quality control the process informs (at 220) seller is informed (e.g., by displaying a message on the display screen of the seller's electronic device or by sending a message to the user's electronic device) and the process ends.

Otherwise, if the remote device passes quality control the process updates (at 225) the reservation system databases and stores the device information as well as the time slots that the seller is willing to rent the remotely controlled device. The process advertises (at 230) the remote device for rental. The process in some embodiments credits (at 235) reward points from the reservation system to sellers when the sellers successfully post a rental device. The process also notifies (at 235) the seller of the successful posting. The process then determines (at 240) whether the remote device is rented before any of the time slots for renting the device expires. When the device is actually rented the process credits (at 245) the seller any applicable rental fee and/or provides additional reward points to the seller. The process then determines (at 250) whether there are any more time slots selected by the seller remains unexpired. If the device was posted for one time rental or the rented time slot was the last time slot, the process exits. Otherwise, if device was posted for multiple rentals, the process proceeds to 240, which was described above. Alternatively, the process proceeds to 210 to test the device after being used prior to renting the device again.

When any time slot expires without the device being rented, the process optionally notifies (at 255) the seller that the time slot has expired. The process then proceeds to 250, which was described above. Process 200 is described for one rental device. The process, however, can be used by a seller to post multiple devices or continue to post additional devices.

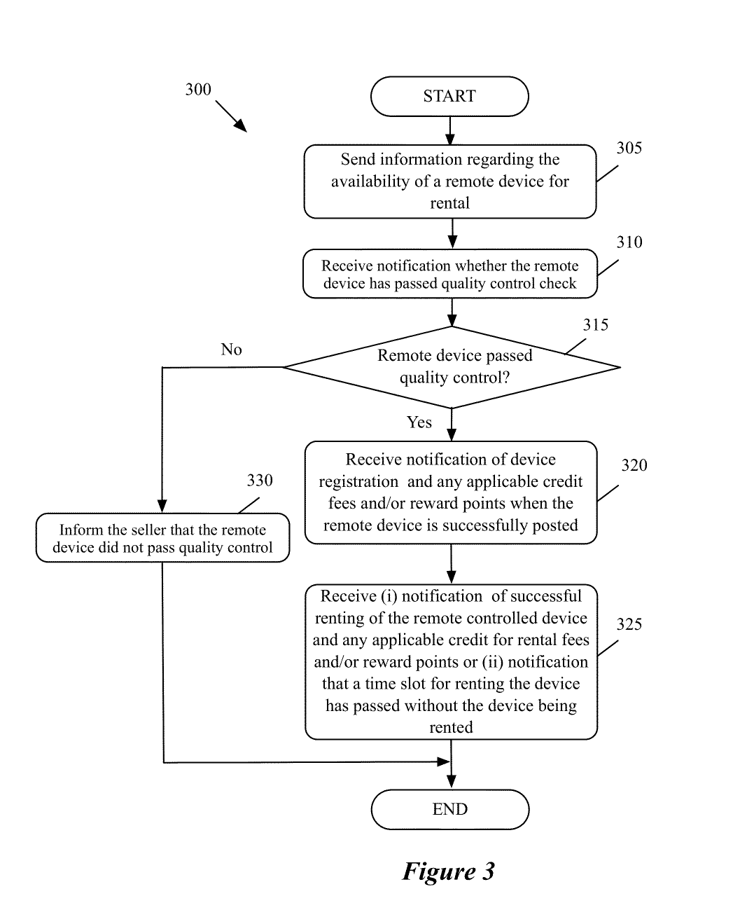

FIG. 3 conceptually illustrates a process 300 for a seller to sell access to remotely controlled devices in some embodiments of the invention. As shown, the process sends (at 305) information regarding the availability of a remote device for rental. For instance, the process sends the information from a seller's electronic device when the seller contacts the reservation system to communicate the availability of a remote device for rental. The contact in some embodiments is a computerized communication where the seller logs into the reservation system and uses its messaging function or uses web site forms. The communication in some embodiments is informal where the seller makes a phone call to the reservation system company and the reservation system receives the information electronically entered in the system by an operator.

The information communicated by the seller to the reservation system includes device information, device availability dates/times, minimum required rent per unit of time, and device access information such as a URL link to it and a temporary username/password. The process then receives (at 310) a notification regarding whether the remote device has passed quality control check by the reservation system. The process then determines (at 315) whether the device passed the quality control test. If not, the process informs (at 330) the user (e.g., by displaying a message on a display screen of the seller's electronic device or by sending an electronic message to the seller's electronic device). The process then exits.

Otherwise, if the remote device passes quality control the process receives (at 320) a notification of the device registration. The process also receives (at 320) any applicable credits or reward points from the reservation system when the device is successfully posted for rent. The process then receives (at 325) a notification that either (i) the device is actually rented as well as receiving any applicable credit for rental fees and/or reward points or (ii) at least one time slot for renting the device has expired without the device being rented. The process then exits.

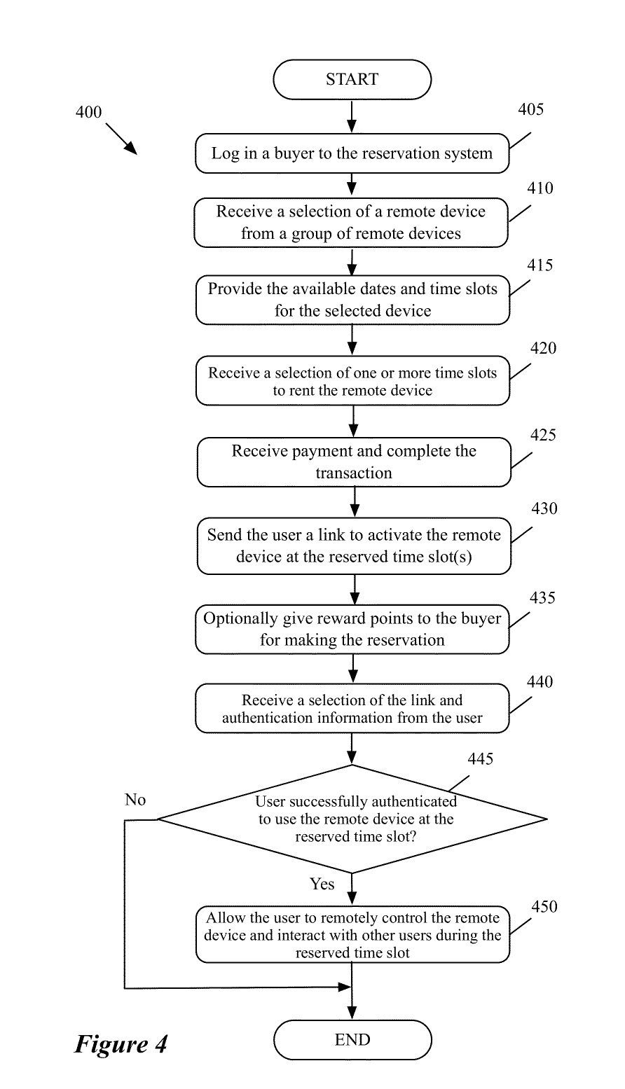

FIG. 4 conceptually illustrates a process 400 for reserving and remotely operating a remote device in some embodiments of the invention. For instance, the process is used by a reservation system to reserve a remote device for a buyer. As shown, the process logs in (at 405) a buyer (e.g., when a buyer uses a computing terminal to log into the reservation system's server with an application or a web browser). If the buyer is not registered with the reservation server, the process asks the user to register. Some embodiments allow the buyer to register/login at a later stage where the user wants to make a payment (as described by reference to operation 425, below). However, users who are not logged-in experience a less personalized service because the reservation system does not know their identity and history.

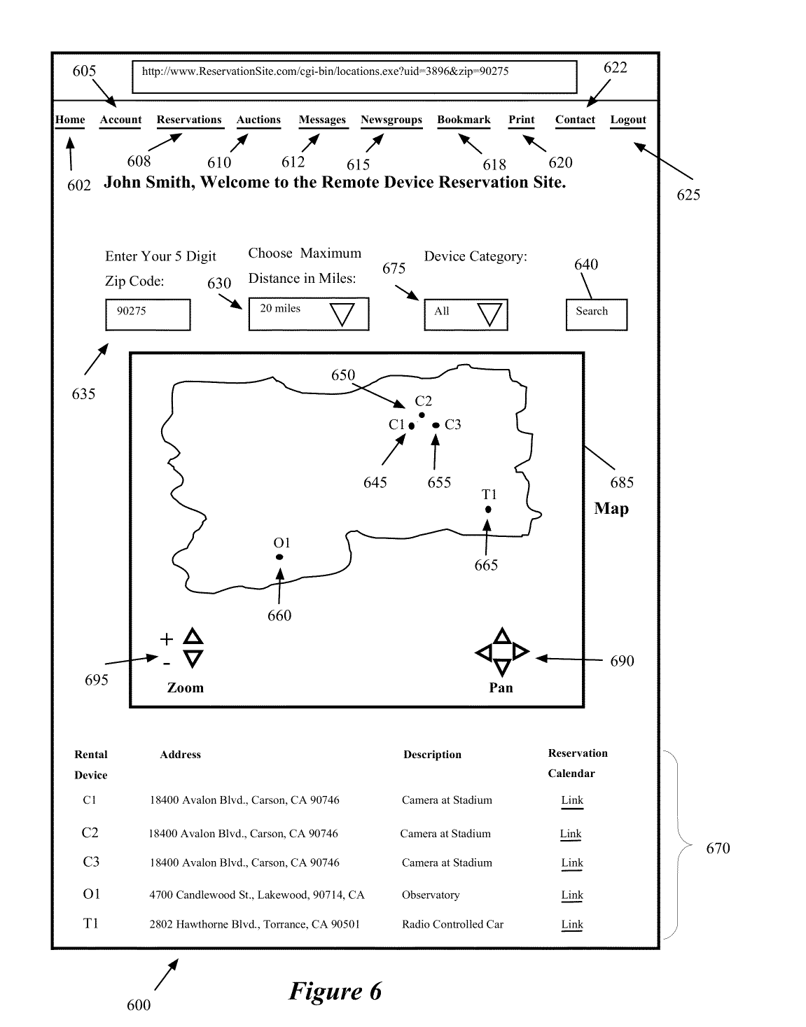

The process then receives (at 410) the buyer's selection of a remote device from a group of remote devices that the reservation system has access to. The process through the user interface of the reservation server's application or web pages provides different mechanisms to assist a buyer to select a remote device to rent. For instance, the process in some embodiments receives a zip code or address from the buyer and in response uses a map server and a corresponding map database to present a map with the marked location of nearest remote devices (e.g., as described by reference to FIG. 6, below) to the user. Alternatively, the process receives a landmark building name from the buyer or allows the buyer to just pan and zoom a map and select a remote device.

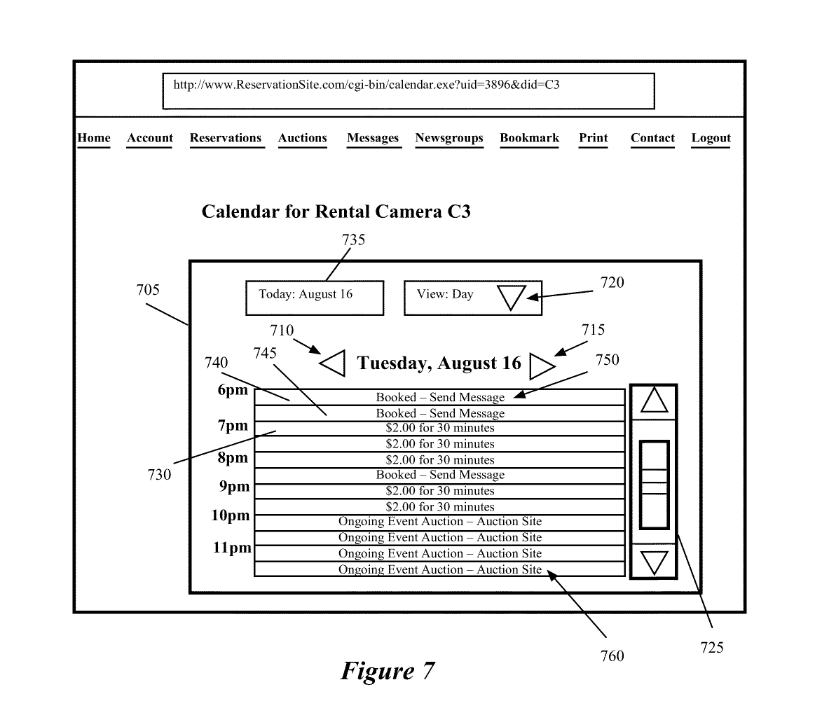

Once the process receives a buyer's selection of a remote device, the process provides (at 415) the buyer with a calendar that shows available dates and timeslots for making a reservation (e.g., as described by reference to FIG. 7, below). The process then receives (at 420) a selection of a timeslot or several timeslots for renting the device. The process then receives (at 425) payment and completes the transaction (e.g., by using the transaction server 160) with a payment method such as a credit card that is in the buyer's profile or a new card that the buyer provides.

After the buyer is successfully charged, the process creates (at 430) a reservation link that is used to activate the remote device at the reserved time slot(s). For instance, this link in some embodiments has name/value pairs that contain the identification of the buyer and the reservation number. The process sends this link (e.g., through the reservation server) to the buyer electronically using a method that is specified in the registered buyer's preferences, such as email to an email address, or text message to a telephone number.

The process also optionally gives (at 435) appropriate rewards points to the buyer for making the reservation. The buyer in some embodiments accumulates reward points and gets a cash-back, makes a new reservation with the rewards points, or sells them to other users.

Next, the process receives (at 440) a selection of the link and authentication information from the user. The buyer uses the link at the reserved timeslot to start a session with the remote device. When the buyer clicks on the link he/she is redirected to login to the reservation server.

The process then determines (at 445) whether the user authentication is successful (e.g., whether the user has in fact reserved the remote device at the requested time slot and has paid for it). If not, the process exits. Otherwise, upon successful authentication the process allows (at 450) the buyer to start the session. The process provides the buyer with a control panel that allows the buyer to interact with the remote device. The controls on the control panel vary depending on the type of the remote device. For instance, a remote video camera or telescope at an observatory have zoom and pan controls, while a remote toy such as a radio controlled model airplane or car have controls for steering and speed control. Most controls allow the buyer to record the session for later playback or for sharing with others using email or social networking sites such as Facebook™ and Twitter™. The session allows the buyer to chat with other registered users that have not blocked him/her. The session also has information link that are relevant to the remote device or the event. For example, for a sporting event the links can provide information about the teams, their scores, players, etc. Finally the session ends when the reservation time is over or if the buyer decides to pre-maturely end the session.

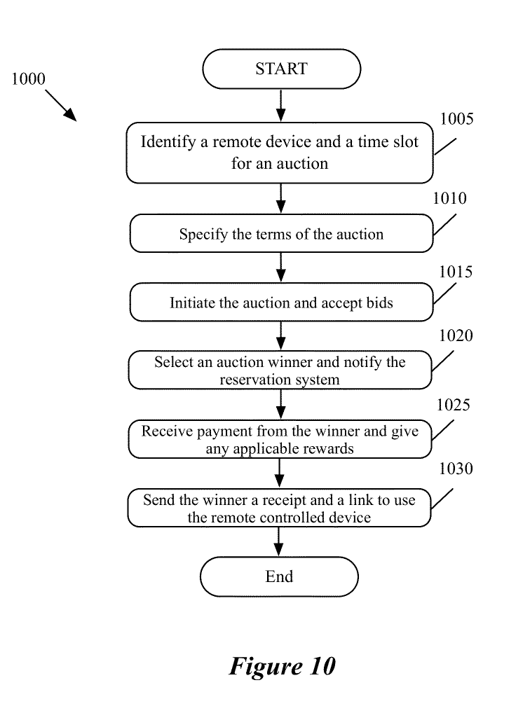

In some embodiments, the calendar also provides timeslots where renting the remote device is being auctioned. If a user is interested in an auctioned timeslot the user has to participate in the auction and win the auction to reserve that timeslot (as described by reference to FIG. 10, below). The calendar also allows the user to use the communication server and anonymously contact other users who have reserved a particular timeslot. For instance, a buyer interested in a reserved timeslot may contact another buyer who has the reservation and offer to buy the reserved time slot at an agreed upon price. They could then use the reservation system's transaction server for a fee to transfer payments between each other and transfer the reservation. A buyer who has a reservation and wants to re-sell it can also use the system's communication server to post the item to newsgroups or use the auction server to set up an auction for it. The system's transaction server can be used for this transaction too. This is an example where a buyer becomes a seller and re-sells his/her reservation for a profit, or because of other reasons such as a schedule conflict.

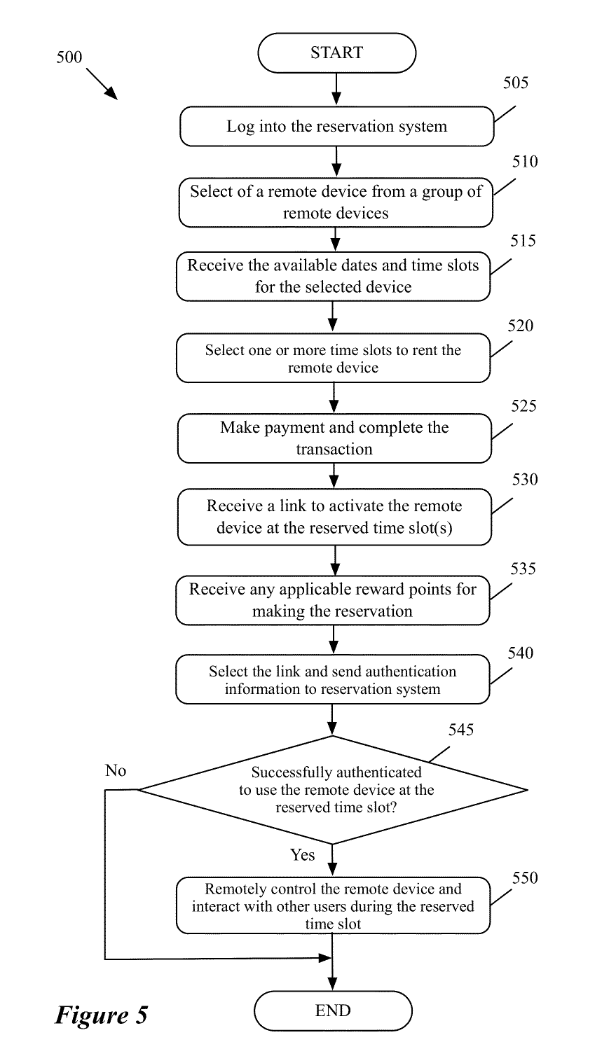

FIG. 5 conceptually illustrates a process 500 for reserving and remotely operating a remote device in some embodiments of the invention. For instance, the process is used by a buyer's electronic device to reserve a remote device. As shown, the process logs in (at 505) the buyer into the reservation system (e.g., when the buyer uses a computing terminal to log into the reservation system's server with an application or a web browser). The buyer also registers with the reservation system is the buyer is not registered. Some embodiments allow the buyer to register/login at a later stage where the user wants to make a payment (as described by reference to operation 525, below).

The process then selects (at 510) a remote device from a group of remote devices that the reservation system has access to. The process then receives (at 515) a calendar that shows available dates and timeslots for making a reservation (e.g., as described by reference to FIG. 7, below). The process then selects (at 520) one or more timeslots for renting the device. The process then makes (at 525) payment and completes the transaction.

The process then receives (at 530) a link for activating and controlling the remote device. The process also receives (at 535) any appropriate rewards points for making the reservation. The buyer in some embodiments accumulates reward points and gets a cash-back, makes a new reservation with the rewards points, or sells them to other users.

Next, the process selects (at 540) the link and sends authentication information to the reservation system. The buyer uses the link at the reserved timeslot to start a session with the remote device. When the buyer clicks on the link he/she is redirected to login to the reservation server.

The process then determines (at 545) whether the user authentication is successful (e.g., whether the user has in fact reserved the remote device at the requested time slot and has paid for it). If not, the process exits. Otherwise, the process provides (550) remote control (e.g., through a control panel) for the buyer to allow the buyer to interact with and remotely control the remote device. The controls on the control panel vary depending on the type of the remote device. For instance, a remote video camera or telescope at an observatory have zoom and pan controls, while a remote toy such as a radio controlled model airplane or car have controls for steering and speed control. Most controls allow the buyer to record the session for later playback or for sharing with others using email or social networking sites such as Facebook™ and Twitter™. The session allows the buyer to chat with other registered users that have not blocked him/her. The session also has information link that are relevant to the remote device or the event. For example, for a sporting event the links can provide information about the teams, their scores, players, etc. Finally the session ends when the reservation time is over or if the buyer decides to pre-maturely end the session.

In some embodiments, the calendar also provides timeslots where renting the remote device is being auctioned. If a user is interested in an auctioned timeslot the user has to participate in the auction and win the auction to reserve that timeslot (as described by reference to FIG. 10, below). The calendar also allows the user to use the communication server and anonymously contact other users who have reserved a particular timeslot. For instance, a buyer interested in a reserved timeslot may contact another buyer who has the reservation and offer to buy the reserved time slot at an agreed upon price. They could then use the reservation system's transaction server for a fee to transfer payments between each other and transfer the reservation. A buyer who has a reservation and wants to re-sell it can also use the system's communication server to post the item to newsgroups or use the auction server to set up an auction for it. The system's transaction server can be used for this transaction too. This is an example where a buyer becomes a seller and re-sells his/her reservation for a profit, or because of other reasons such as a schedule conflict.

FIG. 6 conceptually illustrates an exemplary graphical user interface 600 for a buyer who has logged into the reservation system in some embodiments of the invention. As shown, the interface provides several links on the pages such as a home link 602 for the home page, and an account link 605 that provides the buyer's account information such as their payment credit card information, shipping address, current balance, reward points, privacy settings, etc. The reservation link 608 provides a list of current and past reservations of the buyer. The auctions link 610 provides a list of current and past auctions that the buyer has participated in. The link in some embodiments also lists other auctions which the buyer can filter based on date, price (current winning bid), location, rental device category, etc.

The messages link 612 takes the buyer to the system's messaging page where the buyer can send messages to other users and view received messages from the reservation system and from other users. The messaging system in some embodiments is personalized so that it masks the real identity of users from each other. Some buyers may also disable messaging so other users cannot message them and only the reservation system can send them messages. The newsgroups link 615 allows buyers to form groups and discussions. For instance, the buyers can discuss their rental needs, rental experiences, and rate rental devices. The newsgroup link or some other link can also show a list of users who are online and who have chosen in their privacy settings to make their presence visible to other users. This is one method for a buyer to start a private chat session with another buyer. There could also be chat rooms where anyone entering can chat with all others in the room.

Buyers can also form bookmarks (by using the bookmark link 618) inside the reservation system web page. For example, a buyer can save bookmarks for particular rental devices, discussion threads, auctions, ratings, etc. These bookmarks are similar to bookmarks of web browsers. They allow the user to save a particular web page and store the state of objects on a web page of interest so that a user (buyer or seller) can return to the web page at a later time by selecting that bookmark from a bookmark menu. The bookmark link provides a user interface that allows a buyer or seller to name or rename a particular bookmark (e.g. “devices-within-20 miles-Zipcode-90275”, “Carson-Stadium-Camera1”, etc.), use folders to organize bookmarks, export bookmarks, email/share bookmarks, etc. Other links provide capabilities for printing 620, contacting the reservation system company 622, and logging out 625. The above discussion also applies to sellers.

In FIG. 6 the buyer is using the system to locate devices of interest. The location finding mechanism in some embodiments uses a zip code (or an address) and a distance range to show nearby rental devices on a map server generated map. The buyer can search for all categories of devices as in FIG. 6 or can limit the search to a particular category, such as cameras only. For example, in FIG. 6 the buyer has selected all rental category devices (as shown by 675) within a 20 mile radius (as shown by 630) of zip code “90275” (as shown by 635) and has pressed the “search” button 640 or pressed “enter” key on the keyboard. The reservation system has found five devices 645-665 that match the search criteria and are shown on the map 685; three cameras 645-655 at a sporting stadium, a telescope 660 at an observatory, and a radio controlled car 665. The system lists (as shown by 670) the device's addresses, their descriptions, and links to each device's reservation calendar. The user can then click on the calendar link of a device of interest to check availability and make a reservation. The user can also click on the device on the map to get the device's information and its calendar link. The user interface 600 also provides pan 690 and zoom 695 controls for navigating the map 685. Another search mechanism (not shown) provided by some embodiments is searching based on a point of interest, where the buyer specifies an attraction by name, address, or by pointing to it on a map and the system displays nearby rental devices.

FIG. 7 illustrates the interface after the buyer clicks on the “reservation calendar link” of rental camera device C3 in FIG. 6 in some embodiments of the invention. The calendar 705 shows the current day, which is August 16^{th} (as shown by 735). The buyer is provided with the option to change the calendar to show other days (e.g., by using controls 710 and 715) or change the calendar view (by using control 720) to show the week, month, year, etc. The vertical scroll bars (725) also change the time range view. In FIG. 7 the rental device is available to be booked directly for certain time slots such as 7-7:30 pm 730. The buyer can click on the link for that time slot in which case he/she is presented with a reservation page. The buyer then secures the reservation with a payment method.

In FIG. 7 some of the time slots such as 6-6:30 pm 740 and 6:30-7:00 pm 745 have already been reserved. The system does provide a link where this buyer can send a message (as shown by 750) to the other buyer who has booked this camera. The messaging system in some embodiments hides the identity of the sender and receiver but provides a mechanism where one buyer can make a request or offer an incentive such as repayment with a price premium to assume their reservation slot. The message in some embodiments is indirect where the interested buyer sends a message inquiry to the reservation server and the reservation server contacts the buyer who has the reservation. The replies from the buyer who has the reservation in some embodiments also go indirectly back to the interested buyer.

In FIG. 7 the reservation system's data-mining server has identified certain timeslots that are in high demand based on previous history or based on a new event. The data mining server 165 (shown in FIG. 1) has notified the reservation server about these and the reservation server has assigned the auction server 170 to conduct auctions for those time slots. The calendar 705 provides links to those auctions (e.g., as shown by 760). An interested buyer clicks on the link to see the auction terms such as the current winning bid, bid increments, and auction end time. The buyer can then decide if he/she wants to participate in the auction.

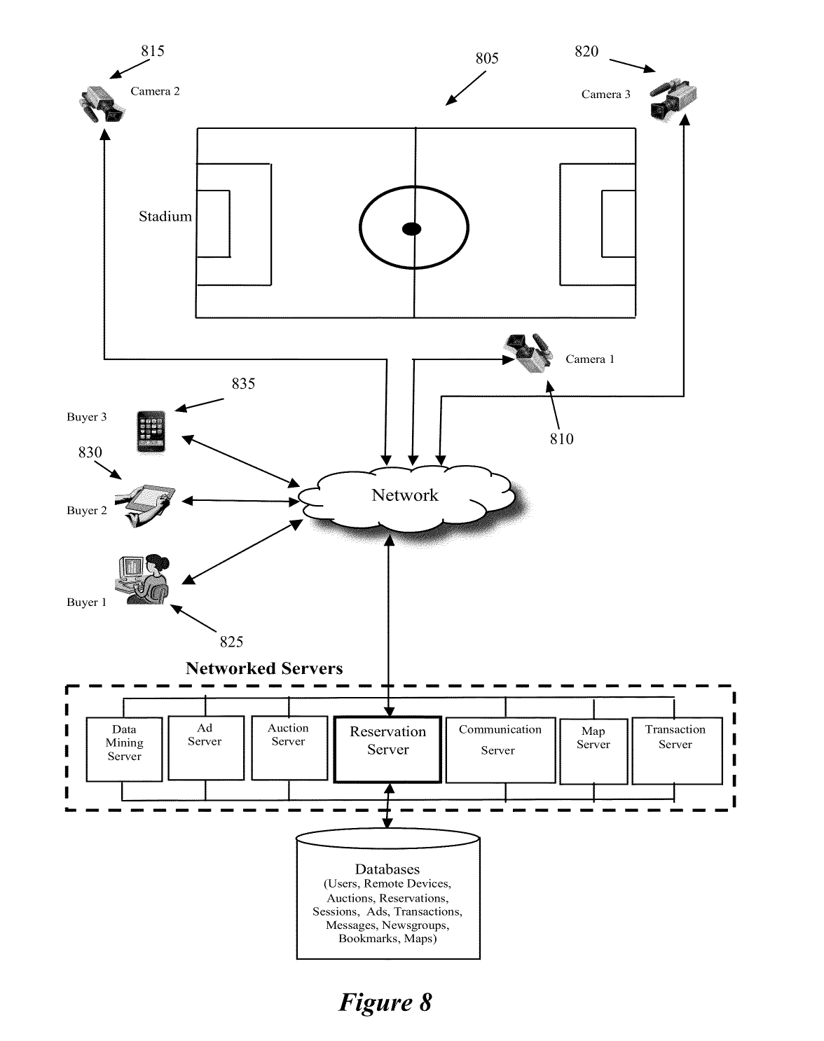

FIG. 8 conceptually illustrates a scenario where a stadium 805 is equipped with IP video cameras 810-820 at different locations in some embodiments of the invention. Each camera can be priced differently according to location, view, and the timeslot. Registered users of the reservation system reserve these cameras and remotely control them during special occasions such as sporting events and concerts. Three buyers 825-835 are shown; buyer 1 825 is controlling camera 1 810, buyer 2 830 is controlling camera 2 815, and buyer 3 835 is controlling camera 3 820.

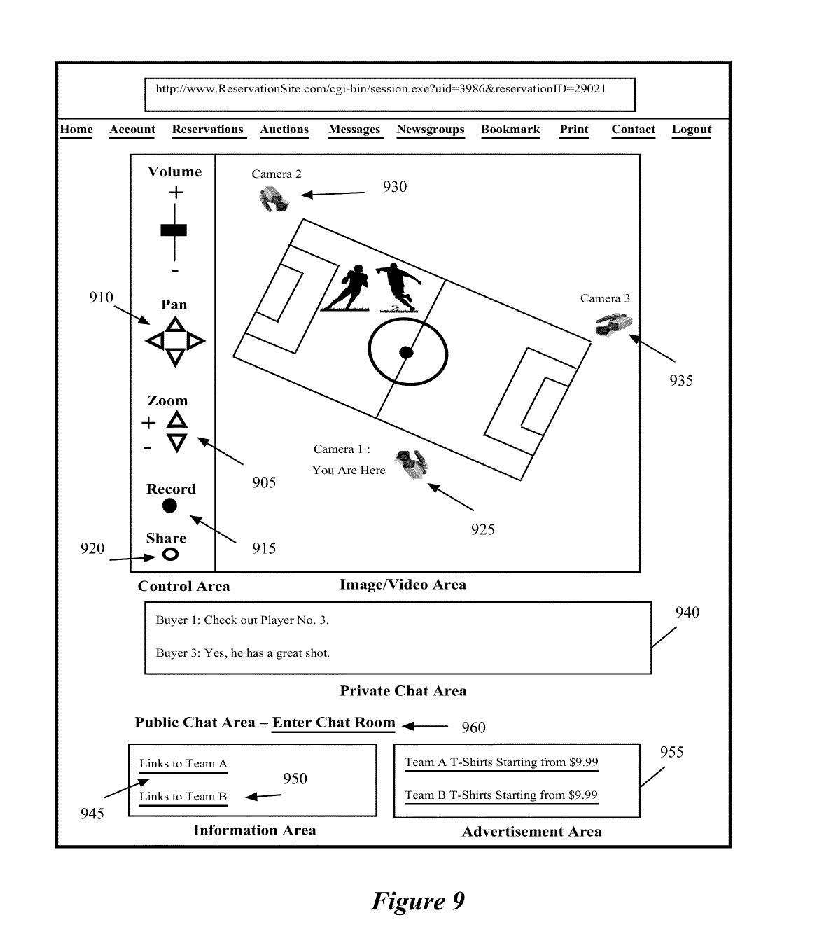

FIG. 9 shows the view of buyer 1 825 in FIG. 8 from reserved camera 1 810. The reservation system uses different playback plugins and applications for each rental device depending on the information generated by the device. In FIG. 9 a video player application is used to display the image/video from the camera. The control panel area also shows different controls depending on the device. In FIG. 9 the controls allow the buyer to change zoom (as shown by 905), pan/tilt (as shown by 910), record the session (as shown by 915), and share (as shown by 920) it with other people using communication methods such as email and social networking sites. As an example, when buyer 1 uses his/her computing device and clicks on the “+zoom” button interface 905 of FIG. 9, the command is transmitted through the Internet to the controller of camera 1 and the camera increases its zoom factor. Camera 1 then transmits a magnified view of the scene through the network back to buyer 1's computing device. The reservation system also allows a registered buyer to communicate with other registered users, depending on their privacy and communication settings, which each user can set under their “Account” page (e.g., after selecting the link 605 in FIG. 6).

In FIG. 9 the reservation system shows the position of the devices of the buyer (camera 1) as well as nearby devices (Cameras 2 and 3) with icons 925-935 respectively. Buyer 1 can click the icons of nearby devices. For example, when buyer 1 clicks on the icon 935 of camera 3 he/she is presented with information about device camera 3. Buyer 1 is also given the option to start a chat session with buyer 3 who is using camera 3, provided the privacy settings of buyer 1 and buyer 3 allow that. In FIG. 9 buyer 1 has clicked on the icon of camera 3 and has started a private chat session (as shown by 940) with buyer 3, where they are discussing the event they are watching from different viewing angles. There is also a link 960 to a public chat room where all users who are signed in the room can post comments and everyone in the room can see the comments.

The reservation system in some embodiments provides additional information that is relevant to the information provided by the remote devices. For instance, in FIG. 9 there are informational links 945 and 950 to the teams that are playing each other. Since some web sites broadcast events, in some embodiments one of the links is a link to a real-time official broadcast of the event. Thus, buyer 1 may view the official broadcast of the event in a separate viewer or window, and at the same time control the camera and see his/her own separate camera view as shown in FIG. 9. If the cameras were instead installed at historic buildings, inside museums, or at nature sites the information links would provide corresponding relevant information about those sites. The reservation system also provides contextual advertisements to users. For example, in FIG. 9 the ads 955 shown are about T-shirts from the two teams that are playing.

FIG. 10 conceptually illustrates a process 1000 for a reservation auction in some embodiments of the invention. As shown, the process identifies (at 1005) a remote device and a time slot for an auction. For instance, the reservation server uses the data-mining server to identify a remote device and a timeslot for an auction. The data-mining server in some embodiments analyzes previous transaction histories and upcoming events. It then identifies pervious high demand events, times, and devices such as a video camera at a stadium for a special sporting event or concert.

Next, the process specifies (at 1010) the terms of the auction. For instance, the reservation server uses the auction server to specify the terms of the auction such as the minimum bid, deposit, auction start and end times, etc. The auction server then publicizes the auction and notifies potential buyers about the auction. The notification mechanism in some embodiments uses push methods such as emails, phone text messages, and web social networking campaigns. The notification in other embodiments uses pull methods such as listings on popular web sites and/or the web site of the auction/reservation server. A buyer who goes to the reservation server and tries to select a remote device for an auction timeslot is also directed to the auction site.

The process then initiates (at 1015) the auction (e.g., through the auction server) and accepts bids from registered buyers. At the end of the auction the process selects (at 1020) the auction server selects the winning bid (e.g., through the auction server) and the winner and forwards that information to the reservation center. The process then receives (at 1025) payment from the winner and gives any applicable rewards. For instance, the reservation server uses the transaction server to accept payment from the winner and give reward points. The process then sends (at 1030) the winner an electronic reservation receipt (e.g., through the reservation server) with a link to use the device at the reserved timeslot. The process then ends.

### III. Electronic System

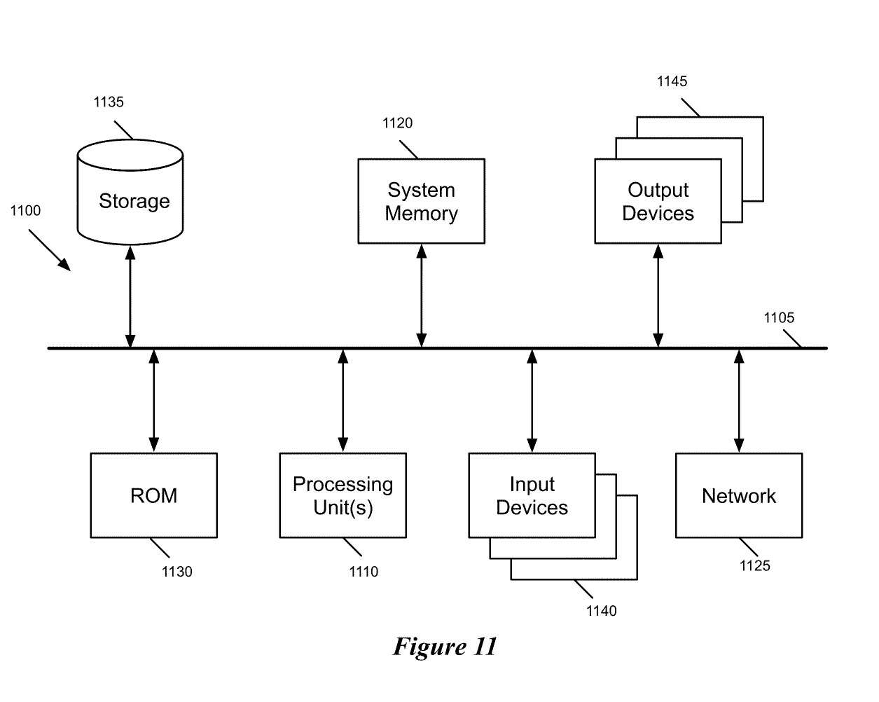

FIG. 11 conceptually illustrates an electronic system 1100 with which some embodiments of the invention are implemented. The electronic system 1100 may be a computer (e.g., a desktop computer, personal computer, tablet computer, server, etc.), phone, PDA, or any other sort of electronic or computing device. Such an electronic system includes various types of computer readable media and interfaces for various other types of computer readable media. Electronic system 1100 in some embodiments includes a bus 1105, processing unit(s) 1110, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the read-only memory 1130, the system memory 1120, and the permanent storage device 1135.

From these various memory units, the processing unit(s) 1110 retrieves instructions to execute and data to process in order to execute the processes of the invention. The processing unit(s) may be a single processor or a multi-core processor in different embodiments.

The read-only-memory (ROM) 1130 stores static data and instructions that are needed by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the invention use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor needs at runtime. In some embodiments, the invention's processes are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the invention.

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of this specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (e.g., FIGS. 2-5 and 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method of reserving and operating remotely operated devices, the method comprising:
providing information to a plurality of users regarding an availability of a remotely operated device for rent in a set of time slots;
reserving the remotely operated device in a particular time slot in the set of time slots for a user in the plurality of users;
providing a set of remote controls to remotely control the device in the particular time slot; and
remotely controlling the device in the particular time slot according to a set of commands received through the provided set of remote controls.

2. The method of claim 1, wherein the user is a first user, the method further comprising:
receiving a request from the first user to share information regarding the remotely operated device with a second user in the set of users; and
providing a tool for the user to share information with the second user when privacy settings of the first and second user allow the requested sharing.

3. The method of claim 2, wherein the information shared comprises information received from the device while the device is being remotely controlled by the first user.

4. The method of claim 1 further comprising remotely testing a quality of the device prior to providing the availability information to the plurality of users, wherein providing information regarding the availability of the remotely operated device comprises providing the availability information after the quality of the device satisfies a criteria.

5. The method of claim 1, wherein the remotely operated device is one of a still camera, a video camera, a telescope, a radio controlled car, a radio controlled plane, a radio controlled ship, a radio controlled submarine, a radio controlled toy, a radio controlled robot, a radio control electronic device.

6. The method of claim 1 further comprising providing electronic messaging, private electronic chat rooms, and public electronic chat rooms for the plurality of users.

7. The method of claim 1, wherein the user is a first user, the method further comprising:
receiving a request from the first user to rent the device in the particular time slot to other users for a particular price;
reserving the remotely operated device in the particular time slot for a second user; and
crediting the first user for the particular price.

8. The method of claim 7, wherein providing the set of remote controls to remotely control the device in the particular time slot comprises providing the set of remote controls to the second user after the remotely controlled device is reserved in the particular time slot for the second user.

9. The method of claim 1 further comprising providing contextual and personalized advertisements to the user while the user is reserving or remotely controlling the device.

10. The method of claim 1, wherein the remotely operated device is owned by a particular user, the method further comprising:
receiving the information regarding the availability of the remotely operated device in the set of time slots from the particular user prior to providing the availability to the plurality of users; and
providing reward points to the particular user when the device becomes available for renting.

11. The method of claim 1, wherein the remotely operated device is owned by a particular user, the method further comprising:
receiving the information regarding the availability of the remotely operated device in the set of time slots from the particular user prior to providing the availability to the plurality of users; and
providing reward points to the particular users when the device is reserved.

12. The method of claim 1 further comprising providing reward points to the user after reserving the device for the user.

13. The method of claim 1 further comprising providing a plurality of web pages to display information regarding a plurality of remotely controlled devices;
receiving a set of bookmarks corresponding to one or more pages in the plurality of the web pages;
saving the bookmarks;
receiving a request to display a page corresponding to a particular saved bookmark; and
displaying the page corresponding to the particular bookmark.

14. The method of claim 1 further comprising:
receiving a request from a user in the plurality of users for availability of remotely controlled devices based on an address; and
providing a map identifying a set of remotely controlled devices within a range of the received address.

15. A method of auctioning available time slots and operating remotely operated devices, the method comprising:
providing information to a plurality of users regarding auction terms for operating a remotely operated device in a set of time slots;
receiving bids from a set of users in the plurality of users for reserving the remotely operated device in the set of time slots;
reserving the device in a particular time slot in the set of time slots for a user in the set of users based on the received bids;
providing a set of remote controls to remotely control the device in the particular time slot; and
remotely controlling the device in the particular time slot according to a set of commands received through the provided set of remote controls.

16. The method of claim 15, wherein the user is a first user, the method further comprising:
receiving a request from the first user to rent the device in the particular time slot to other users for a particular price;
reserving the remotely operated device in the second time slot in the set of time slots from for a second user; and
crediting the first user for the particular price.

17. The method of claim 16, wherein providing the set of remote controls to remotely control the device in the particular time slot comprises providing the set of remote controls to the second user after the remotely controlled device is reserved in the particular time slot for the second user.

18. The method of claim 15, wherein the user is a first user, the method further comprising:
receiving a request from the first user to auction the device in the particular time slot to other users;
providing information to the plurality of users regarding auction terms for operating a remotely operated device in the particular time slots;
receiving bids from a set of users in the plurality of users for reserving the remotely operated device in the particular time slot;
reserving the device in the particular time slot for a second user in the set of users for a particular price based on the received bids; and
crediting the first user for the particular price.

19. The method of claim 15, wherein the remotely operated device is one of a still camera, a video camera, a telescope, a radio controlled car, a radio controlled plane, a radio controlled ship, a radio controlled submarine, a radio controlled toy, and a radio controlled robot.

20. A system for reserving and operating remotely operated devices, the system comprising:
a reservation server to:
provide information to a plurality of users regarding an availability of a remotely operated device for rent in a set of time slots;
reserve the remotely operated device in different time slots in the set of time slots for different user in the plurality of users;
provide a set of remote controls to remotely control the device in each reserved time slot; and
remotely control the device in the each reserved time slot according to a set of commands received through the provided set of remote controls.

21. The system of claim 20 further comprising a transaction server to receive payment from the users for reserving the remotely operated device.

22. The system of claim 21, wherein the transaction server is further to credit reward points to an owner of the remotely operated device when the device is reserved for each time slot.

23. The system of claim 21, wherein the transaction server is further to credit reward points to an owner of the remotely operated device when the device is available for rental for a time slot.

24. The system of claim 20 further comprising an auction server to:
provide information to a plurality of users regarding auction terms for operating a remotely operated device in a set of time slots;
receive bids from a set of users in the plurality of users for reserving the remotely operated device in the set of time slots; and
reserve the device in a time slot in the set of time slots for a user in the set of users based on the received bids,
wherein the reservation server is further to:
provide a set of remote controls to remotely control the device in the time slots reserved in the auction; and
remotely controlling the device in the time slots reserved in the auction according to a set of commands received through the provided set of remote controls.

25. The system of claim 24 further comprising a data-mining server to:
analyze historical data and patterns; and
provide the historical data and patterns to the auction server,
wherein the auction server is further to utilize the historical data and patterns to auction remotely operated devices in particular time slots.

26. The system of claim 20 further comprising:
a data-mining server to analyze historical data and patterns; and
an advertising server to provide contextual and personalized advertisements based on the historical data and patterns to users while the users are reserving or remotely controlling the device.

27. The system of claim 20 further comprising a map server to:
receive requests for identifying remotely operated devices based on addresses or geographical information; and
providing a map that identifies remotely operated devices based on the received addresses or geographical information.

28. The system of claim 20 further comprising a communication server to provide electronic messaging, private electronic chat rooms, and public electronic chat rooms for the users of the reservation server.

29. A machine readable medium storing a program for reserving and operating remotely operated devices, the program comprising a graphical user interface (GUI), the program executable by at least one processing unit, the GUI comprising:
a tool for receiving a request to display remotely operated devices based on an specified address;
a display area for:
displaying a map based on the specified address; and
displaying a set of remotely operated devices within a range of the specified address;
a tool for selecting a remotely operated device displayed on the map;
a display area for displaying a set of time slots for a selected remotely operated device; and
a tool for reserving the remotely operated device on a particular time slot.

30. The machine readable medium of claim 29, wherein the GUI further comprises:
a display area for displaying a plurality of time slots for a selected remotely operated device to show the time slots where the remotely operated device is available for rent and the time slots where the use of the remotely operated device is available for auction.

31. The machine readable medium of claim 29, wherein the GUI further comprises a display area for displaying a set of controls for controlling a remotely operated device in a reserved time slot.

32. The machine readable medium of claim 30, wherein the GUI further comprises a tool for recording a session where a remotely operated device is being remotely controlled by a user.

33. The machine readable medium of claim 29, wherein the GUI further comprises an electronic chat room for a user who is remotely controlling a device to privately chat with other users.

34. The machine readable medium of claim 29, wherein the GUI further comprises an public electronic chat room for a plurality of registered users to chat.
